(19) United States
(12) Patent Application Publication
(10) Pub. No.: US 2013/0060790 A1
(43) Pub. Date: Mar. 7, 2013

(54) SYSTEM AND METHOD FOR DETECTING OUTLIERS

(71) Applicants: Michael CHERTOK, Petah Tikva (IL); Adi Pinhas, Hod Hasharon (IL)

(72) Inventors: Michael CHERTOK, Petah Tikva (IL); Adi Pinhas, Hod Hasharon (IL)

(21) Appl. No.: 13/227,200

(22) Filed: Sep. 7, 2011

(51) Int. Cl. G06F 17/30

(52) U.S. Cl. 707/752; 707/E17.031

(57) ABSTRACT

A system and method for detecting outliers. A method may include selecting, from a first subset of digital objects, a second subset of digital objects, sorting the first subset of digital objects according to a similarity to at least some of the objects included in the second subset, and, designating at least one digital object included in the first subset as an outlier based on the sorting. A similarity value indicative of a level of similarity between an object and a reference object may be associated with the object. A set of objects may be sorted according to their associated similarity values.

### BACKGROUND OF THE INVENTION

The purpose of information retrieval is to bring relevant information, e.g., in response to a user's query. Information retrieval in general and image retrieval particular are prone to outliers. Outlier is a scientific term to describe results that lie outside normal experience or expected results. An Outlier may be a result that is numerically distant from the rest of the results or data. In particular, when image retrieval is relevant, e.g., in retrieving images similar to an input or query image, an outlier may be especially disturbing.

### SUMMARY OF EMBODIMENTS OF THE INVENTION

A system and method for detecting outliers. A method may include selecting, from a first subset of digital objects, a second subset of digital objects, sorting the first subset of digital objects according to a similarity to at least some of the objects included in the second subset, and, designating at least one digital object included in the first subset as an outlier based on the sorting. A similarity value indicative of a level of similarity between an object and a reference object may be associated with the object. A set of objects may be sorted according to their associated similarity values. A similarity value indicative of a level of similarity between an object and a set of images may be associated with the object. Outliers may be identified based on a sorted set of images, objects or elements.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 shows high level block diagram of an exemplary computing device according to embodiments of the present invention.

FIG. 1A schematically shows an exemplary arrangement of digital objects in a space according to embodiments of the invention;

FIG. 2 schematically shows an exemplary arrangement of objects and a table related to similarities according to embodiments of the invention;

FIG. 3 schematically shows an exemplary arrangement of objects and a representation of a subset of objects in a space according to embodiments of the invention;

FIG. 4 schematically shows an exemplary arrangement of objects and a table related to similarities according to embodiments of the invention;

FIG. 5A schematically shows an exemplary arrangement of objects and relevant similarities according to embodiments of the invention;

FIG. 5B schematically shows an exemplary arrangement of objects and a table related to similarities according to embodiments of the invention; and

FIG. 6 shows a flowchart describing a method according to embodiments of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

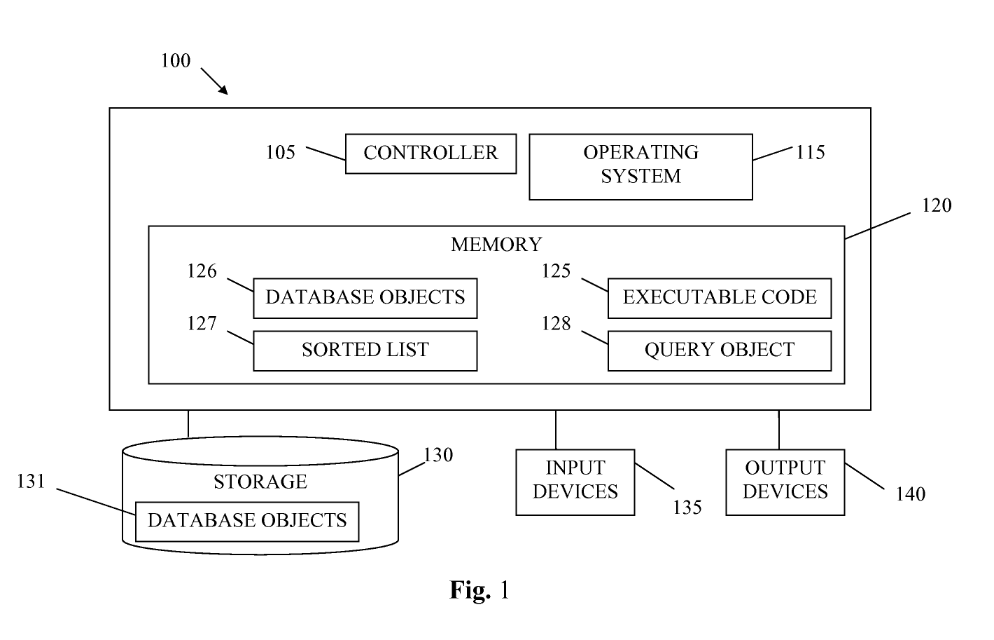

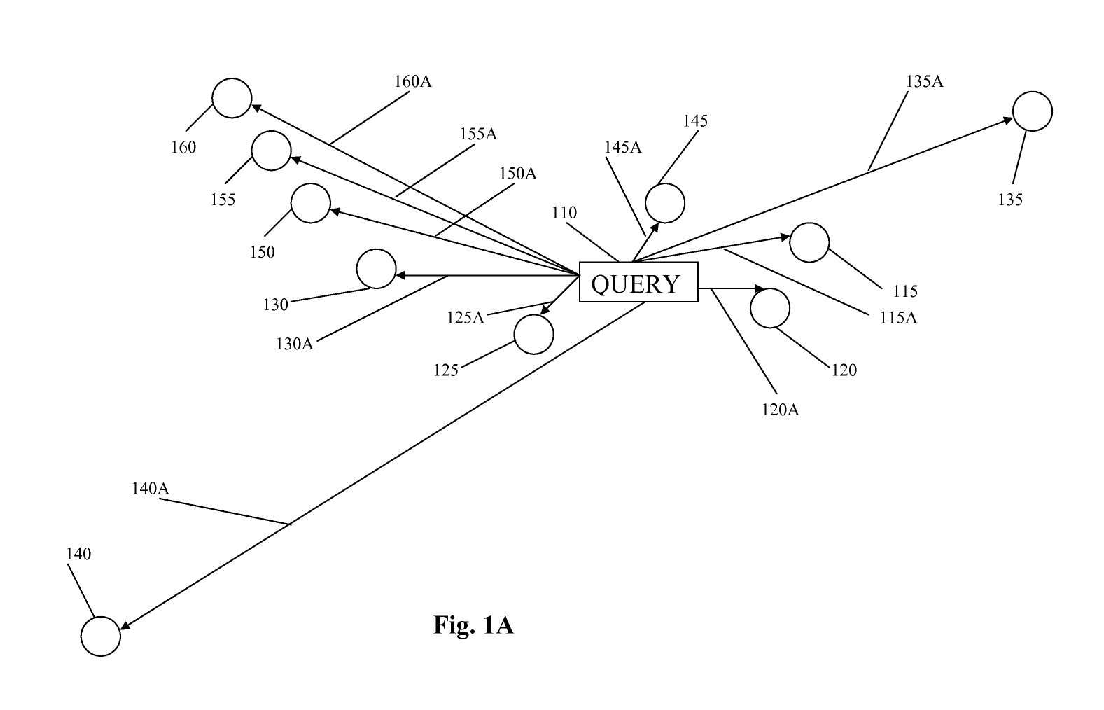

Reference is made to FIG. 1, that shows a high level block diagram of an exemplary computing device according to embodiments of the present invention. Computing device 100 may include a controller 105 that may be, for example, a central processing unit processor (CPU), a chip or any suitable computing or computational device. Computing device 100 may include an operating system 115, a memory 120, a storage 130, an input devices 135 and an output devices 140.

Operating system 115 may be or may include any code segment designed and/or configured to perform tasks involving coordination, scheduling, arbitration, supervising, controlling or otherwise managing operation of computing device 100, for example, scheduling execution of programs. Operating system 115 may be a commercial operating system. Memory 120 may be or may include, for example, a non-transitory storage medium, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units.

Executable code 125 may be any executable code, e.g., an application, a program, a process, task or script. Executable code 125 may be executed on or by controller 105 possibly under control of operating system 115. For example, executable code 125 may be an application that may be provided with a set of digital images (e.g., in the form of a set of pixels), process the set of images, e.g., as described herein, in order to identify or determine specific parameters related to the images, sort a set of images according their associated parameters and according to a reference image (e.g., included in a query), e.g., in an ascending order, display the identified image on a display of computing device 100 and/or send an image to a remote server. Storage 130 may be or may include, for example, a database and associated application, a hard disk drive, a floppy disk drive, a Compact Disk (CD) drive, a CD-Recordable (CD-R) drive, a universal serial bus (USB) device or other suitable removable and/or fixed storage unit. Digital images may be stored in storage 130 (e.g., in the form of a set of pixels) and may be loaded from storage 130 into memory 120 where they may be processed by controller 105, e.g., in order to identify and/or determine specific parameters, determine a relation of an image to a specific reference image, a set of reference images or to any other reference, e.g., as described herein.

As shown, storage 130 may store database objects that may be, for example, digital images or any other content objects. As shown by 126, database objects may be loaded into memory 120 and may be processed, sorted (e.g., in an ascending or descending order), selected or otherwise manipulated by controller 105, e.g., according to instructions in executable code 125. As shown by 128, a query object may be loaded into memory 120 and may be used as a reference. One or more sorted lists may be generated and stored in memory 120 as shown by 127. For example, a sorted list may include database objects that may be sorted according to one or more criteria, e.g., a distance from a query object, a distance from a center of mass defined by a set of images or objects and the like. In another embodiment, a sorted list may not include database object but rather, include references to database objects where the references may be sorted according to one or more criteria and according to parameters or attributes of referenced objects. According, various methods for sorting database objects may be implemented without departing from the scope of the invention.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays or any other suitable output devices. It will be recognized that any suitable number of output devices may be operatively connected to computing device 100 as shown by block 140. Any applicable input/output (I/O) devices may be connected to computing device 100 as shown by blocks 135 and 140. For example, a wired or wireless network interface card (NIC), a printer or facsimile machine, a universal serial bus (USB) device or external hard drive may be included in input devices 135 and/or output devices 140.

Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, a storage medium such as memory 120, computer-executable instructions such as executable code 125 and a controller such as controller 105.

Some embodiments may be provided in a computer program product that may include a non-transitory machine-readable medium, stored thereon instructions, which may be used to program a computer, or other programmable devices, to perform methods as disclosed herein. Embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which when executed by a processor or controller, carry out methods disclosed herein. The storage medium may include, but is not limited to, any type of disk including floppy disks, optical disks, compact disk read-only memories (CD-ROMs), rewritable compact disk (CD-RWs), and magneto-optical disks, semiconductor devices such as read-only memories (ROMs), random access memories (RAMs), such as a dynamic RAM (DRAM), erasable programmable read-only memories (EPROMs), flash memories, electrically erasable programmable read-only memories (EEPROMs), magnetic or optical cards, or any type of media suitable for storing electronic instructions, including programmable storage devices.

A system according to embodiments of the invention may include components such as, but not limited to, a plurality of central processing units (CPU) or any other suitable multi-purpose or specific processors or controllers, a plurality of input units, a plurality of output units, a plurality of memory units, and a plurality of storage units. A system may additionally include other suitable hardware components and/or software components. In some embodiments, a system may include or may be, for example, a personal computer, a desktop computer, a mobile computer, a laptop computer, a notebook computer, a terminal, a workstation, a server computer, a network device, or any other suitable computing device. Unless explicitly stated, the method embodiments described herein are not constrained to a particular order or sequence. Additionally, some of the described method embodiments or elements thereof can occur or be performed at the same point in time.

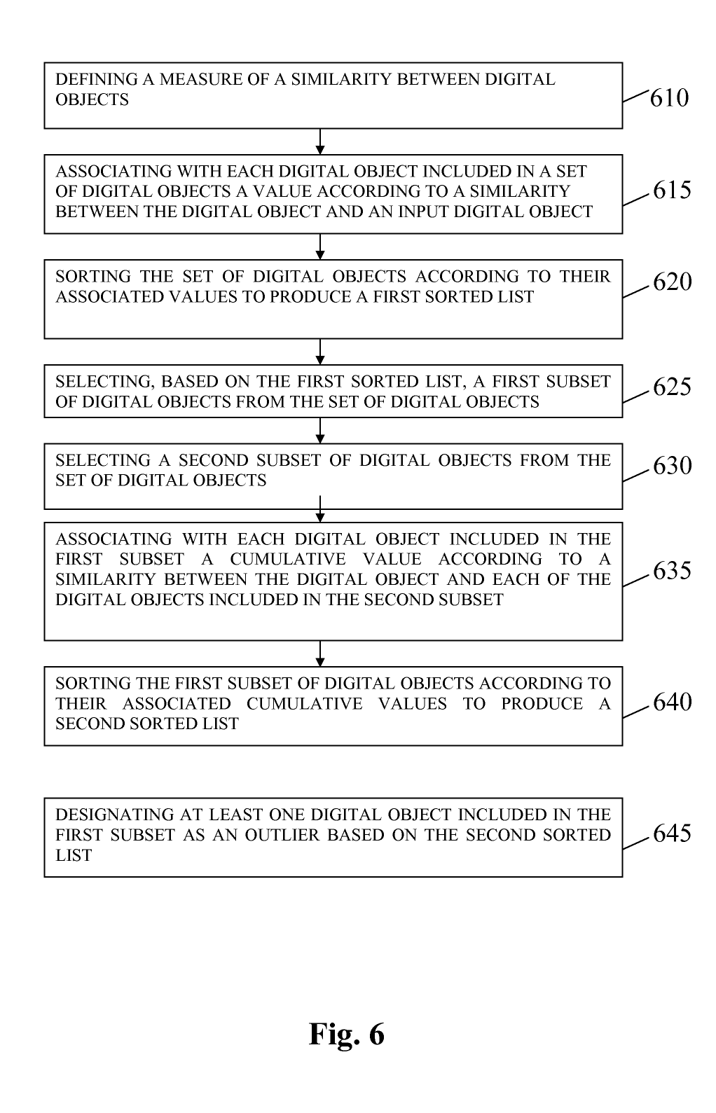

Reference is made to FIG. 6 that shows a flowchart describing a flow or method according to embodiments of the invention. As shown by block 610, the method or flow may include defining a measure of a similarity between digital objects. For example, a similarity may be expressed by defining a measure of a distance between digital objects in a multidimensional space. For example, the digital objects may be or may include digital images and dimensions of a space may be a color distribution, a hue, an intensity, a brightness, a luminance, a chromaticity and/or a saturation. Other attributes of images may be used as dimensions of a space, e.g., a size, a resolution. In such space, an image may be represented by a vector or a location based on its color distribution and/or levels of hue, intensity, brightness, luminance, chromaticity, saturation and/or any other imaging parameter (e.g., associated with pixels representing the digital image). For example, controller 105 may load an image from storage 130 (e.g., load one of database objects 131) into memory 120 (e.g., as shown by 126) and examined pixels in the loaded image to determine a vector representing the loaded image in a space defined by a set of imaging parameters. A vector or other parameter may be computed, calculated or generated for each image in a database. For example, a module may process each image added to a database and may record the image's vector or location in a space. Although images are mainly referred to herein, other digital objects may be applicable. For example, dimensions of a space used for evaluating similarities between documents containing text may be font size, font style or any other font attributes, formatting parameters, subject discussed in a document and the like. Accordingly, although a similarity is exemplified herein as a distance in a space defined by imaging parameters, it will be understood that embodiments of the invention are not limited in this respect.

As shown by block 615, the method or flow may include associating with each digital object included in a set of digital objects, a value according to a similarity between the digital object and an input digital object. For example, the level of a similarity between each image included in a set of images and an image included in a query may be determined and associated with the relevant image. For example, the distance in a defined space from a specific image in a set and an image in a query may be associated with the specific image in the set.

Reference is additionally made to FIG. 1A that schematically shows an exemplary arrangement of objects and relevant distances in a space according to embodiments of the invention. For the sake of clarity and simplicity, the discussion herein will be related to a two dimensional space. However, it will be understood the embodiments of the invention may be applicable to spaces of higher dimensions. In some embodiments, a space used may have a large number of dimensions, e.g., five or six imaging parameters may be used as five or six dimensions of a space. As shown, a query 110 and database or digital objects 120-160 may be mapped to a location in a space. As further shown by arrows 120A-160A, the distances from each of digital objects 120-160 to query 110 may be determined. The distances 120A-160A may represent the similarities between objects 120-160 and query 110. For example, query 110 may include an image and may be generated in order to find similar images. Objects 115, 120, 125, 130, 135, 140, 145, 150, 155 and 160 may be s subset of images selected from a set of images in database or storage 130. For example, objects 115, 120, 125, 130, 135, 140, 145, 150, 155 and 160 may be selected as the most similar (or the closest) images with respect to an image in query 110.

It will be understood that other ways of representing a similarity may be used and that the discussion herein with respect to distance is intended for clarity, accordingly, embodiments of the invention are not limited to calculating a similarity between digital objects using a distance in a space as described herein. Although embodiments of the invention may be related to various digital objects, the discussion herein will mainly refer to digital images. As shown, digital object 145 is closer to query 110 than digital object 140. For example, one or more imaging parameters of digital object 145, e.g., a color distribution and/or a level of saturation of the red color in digital object 145 may be similar to those of query 110 but different from those of digital object 140.

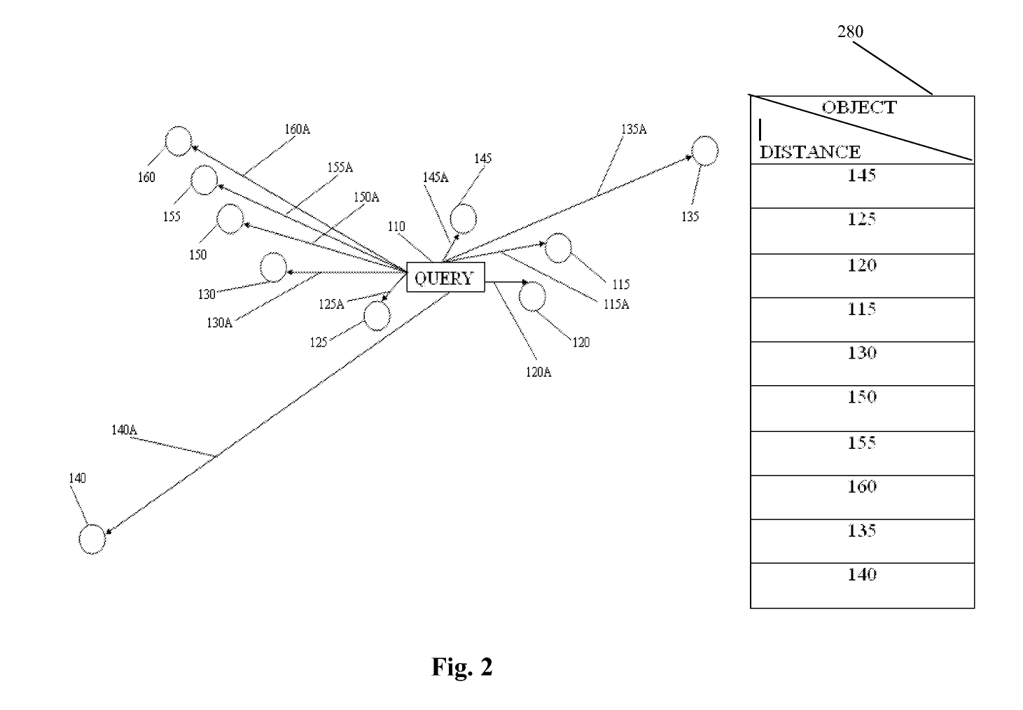

As shown by block 620, the method or flow may include sorting the set of digital objects according to their associated values to produce a first sorted list. Reference is additionally made to FIG. 2 that schematically shows an exemplary arrangement of objects and a table 280 related to similarities according to embodiments of the invention. As shown, table 280 may be a sorted list in which digital objects 120-160 may be sorted according to their similarity to query 110. As shown, digital object 125 which is close to query 110 is located higher in sorted list 280 than digital objects 120 and/or 140 which are farther from query 110. Accordingly, the sorting may represent a level and/or order of similarity. It will be understood that sorting objects according to their similarity to an input object (e.g., an object in a query) may be according to various schemes. For example, a center of mass may be calculated for a small set of objects and a similarity of other objects to a center of mass object may be used in order to sort the objects.

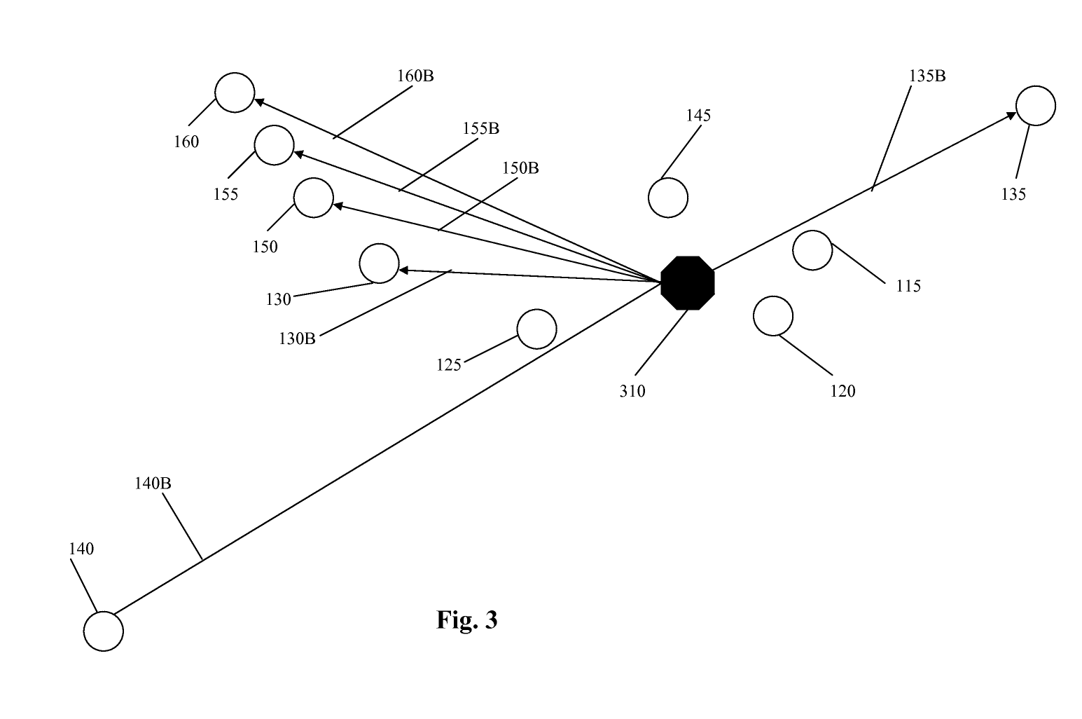

Reference is additionally made to FIG. 3 that schematically shows an exemplary arrangement of objects and a representation of a subset of objects in a space according to embodiments of the invention. As shown by 310, a center of mass or other representation of digital objects 115, 120, 125 and 145 may be generated or defined. For example, digital objects 115, 120, 125 and 145 may be chosen to be represented by 310 since they are the closest objects to query 110. Any set of close objects may be selected based on one or more rules or criteria, e.g., the closest ten or hundred objects, all objects at or below a specific distance from query 110 may be selected. As further shown by arrows 130B, 135B, 140B, 150B, 155B and 160B, a similarity of objects 130, 135, 140, 150, 155 and 160 from 310 may be determined, e.g., according to the distances of these objects from query 110. Table 280 may be populated based on similarities with a representation of a subset of objects or images such as representation 310.

As shown by block 625, the method or flow may include selecting, based on the first sorted list, a first subset of digital objects from the set of digital objects. For example, table 280 may include thousands of entries related to thousands of digital objects (not shown) in a database and digital objects 120-160 may be a subset selected from such large set. For example, a subset of a thousand objects may be selected from a much larger set of objects by selecting the top thousand objects in a sorted list such as list 280.

As shown by block 630, the method or flow may include selecting a second subset of digital objects from the set of digital objects. For example, a second subset may be selected based on a sorted list. For example, objects 115, 120, 125 and 145 may be selected since they are at the top of sorted list 280. Any number of objects may be selected to be included in the second subset and any rule or criteria may be used in order to select objects to be included in the second subset.

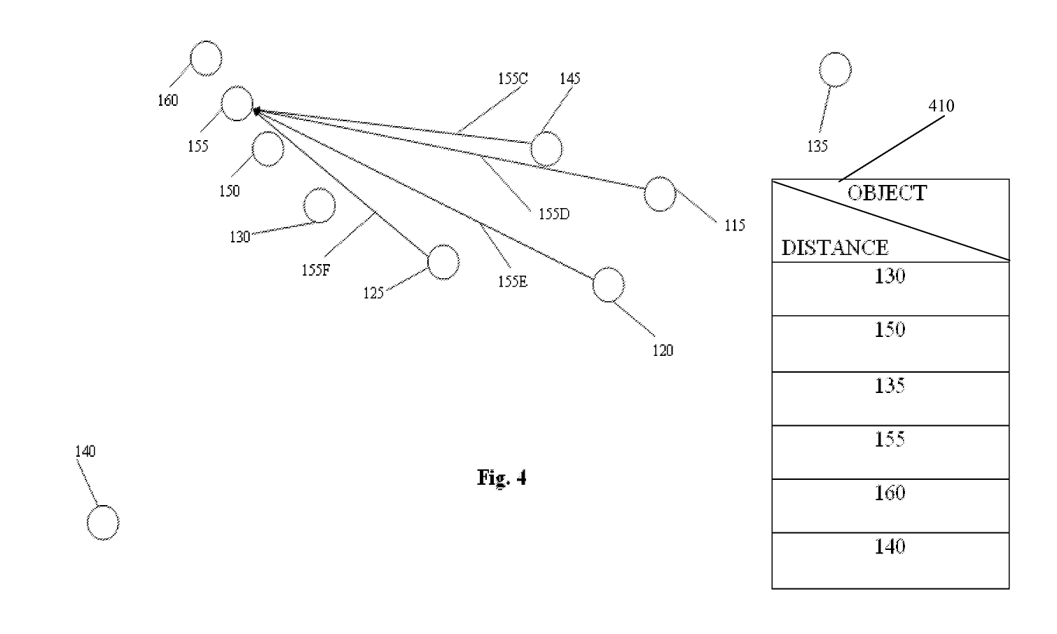

As shown by block 635, the method or flow may include associating with each digital object included in the first subset a cumulative value according to a similarity between the digital object and each of the digital objects included in the second subset. Reference is additionally made to FIG. 4 that schematically shows an exemplary arrangement of objects and a table 410 related to similarities according to embodiments of the invention. As shown by arrows 155C, 155D, 155E and 155F, that similarity of object 155 with objects 115, 120, 125 and 145 may be determined. For example, a cumulative sum of distances from object 155 with objects 115, 120, 125 and 145 as shown by arrows 155C, 155D, 155E and 155F may be calculated and associated with object 155. Likewise, a cumulative sum of distances from objects 130, 140, 150 and 160 may be calculated and associated with the relevant object. As shown by table 410, a sorted list may be generated such that it reflects the level of similarity of each objects in the first subset with objects in the second subset where a level of a similarity may be a cumulative sum of values representing a set of similarities, e.g., the similarities. For example, a value associated with object 155 may be related to the sum of distances from object 155 to objects 115, 120, 125 and 145 as shown by arrows 155C, 155D, 155E and 155F.

As shown by block 640, the method or flow may include sorting the first subset of digital objects according to their associated cumulative values to produce a second sorted list. For example, a second sorted list may be as shown by table 410.

As shown by block 645, the method or flow may include designating at least one digital object included in the first subset as an outlier based on the second sorted list. Outliers may be omitted from a list of items to be presented to a user. For example, query 110 may include an image and may be generated in order to find similar images. Accordingly, a list of similar images may be generated by determining a similarity of images in a database to the image in query 110. The list of images thus produced may be presented to a user or otherwise provided. Some images that may have been selected (e.g., as shown by FIG. 1A) may later be identified or suspected as outliers and may be omitted from the list. For example, objects 160 and 140 which are located at the bottom of table 410 may be assumed to be outliers and may be designated as such and may, for example, be omitted from the set of images provided as a response to query 110.

It will be noted that a sorting of objects or images based on their similarity to an input or query image or object may not be the same as the sorting of objects or images based on their similarity to a collection or subset of objects or images. For example, when sorting according to a similarity with query 110, object 135 placed below objects 160 and 155 as shown by table 280. However, when sorting objects according to their similarity with the subset of objects 115, 120, 125 and 145 as shown by table 410 in FIG. 4, object 135 is placed higher than objects 155 and 160 reflecting a higher similarity. Accordingly, although according to a first sorting, an object may be a candidate for presentation, e.g., as a similar image in response to a query, a second sorting may cause such object to be rejected or designated as an outlier.

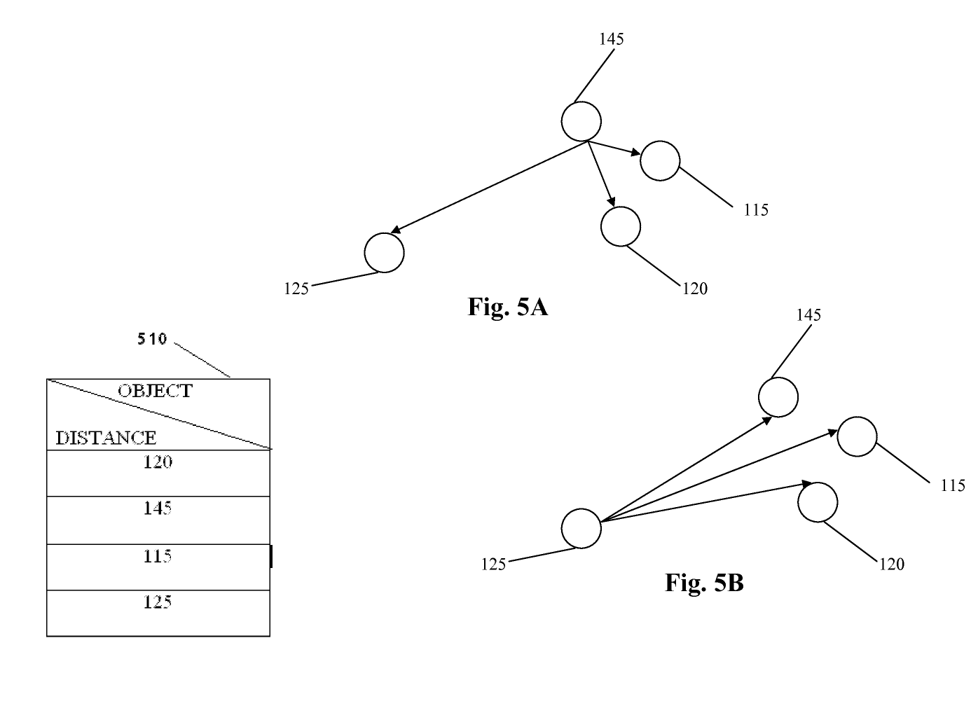

According to some embodiments of the invention, objects in a set or subset may be sorted by determining the respective similarities between each object and all other objects in the set or subset. For example, the objects determined to be the most similar to query 110, e.g., objects 115, 120, 125 and 145 may be examined and, for each of them, a cumulative similarity value may be calculated according to its similarity to all other objects in the subset. Reference is additionally made to FIGS. 5A and 5B that exemplary shows an arrangement of objects and a table 510 related to similarities according to embodiments of the invention. As shown by FIG. 5A the distances from object 145 to objects 115, 120 and 125 may be observed and a cumulative similarity value may be associated with object 145 based on its similarity to objects 115, 120 and 125. Similarly, a cumulative similarity value may be associated with object 125 based on its similarity to objects 115, 120 and 155 as shown by FIG. 5B.

As shown, since object 125 is far from the group of objects 115, 120 and 145, the cumulative distances (representing a similarity) from object 125 to other objects is larger than the cumulative distances of other objects in the set from neighboring objects. This topology is reflected in sorted table 510 where object 125 is located at the bottom. When comparing table 280 in which objects are sorted according to their similarity to query 110 and table 510 in which objects are sorted according to their similarity to a selected set of most similar objects it is noted that a first digital object located higher than a second digital object according to a first sorted list may be located lower than the second digital object according to a second sorted list. For example, in table 280, object 120 is in third place from the top, below objects 145 and 125 (who may be more similar to query 110 than object 120). However, in table 510, object 120 is at the top, above objects 145 and 125. Such phenomena may be more likely when additional dimensions are added to a space used for measuring a similarity or distance between images.

Operations described herein may be also be described using mathematical terms.

For example, images in a portion of a database or even in an entire database of images may be ranked or sorted with respect to a query image, e.g., a query may search for the images most similar to a query image. For example, such query may be generated when a user requests to be provided with a set of images from a database, that are similar to a selected image, in such case, the selected image will be included in the query and images in the database which are similar to the selected image may be provided. For example, images, objects or elements Xᵢ in a database may be sorted according to query Qᵢ where the ranking or sort order is denoted by Rᵢ. A first subset may be selected, e.g., the top one thousand (1000) elements in a sorted list may be selected, e.g., assumed as best so far candidates, or currently most similar. A second subset may be selected, e.g., the top five (5) elements in the above first subset of 1000 elements may be selected. For example, a first subset may be all ten (10) elements in table 280 and the second subset may be only the top three elements in table 280 (145, 125 and 120).

A level of similarity may be calculated for each of the elements, objects or images in the first subset based on images in the second set. For example, the level of similarity may be expressed by a distance. The distances from each of the images in the first subset to each one of the images in the second set may be determined and, based on these distances, a cumulative distance value may be associated with each image in the first subset.

For example, a cumulative similarity or distance value for an image in the first set (e.g., the subset of 1000 elements in the above example) may be derived by a summation of all distances of the image from each of the images included in a second subset (e.g., the subset of 5 elements in the above example).

Referring to the above example, the a similarity value of element rᵢ included in the set of 1000 elements with respect to an element rⱼ included in the set of 5 elements, e.g., expressed as distance, may be expressed by:

$${d}_{ij} = ‖ {r}_{i} - {r}_{j} ‖ , i ∈ \{ 1 , … , 1000 \} , j ∈ \{ 1 , … , 5 \} .$$

A cumulative similarity value of element rᵢ included in the set of 1000 elements with respect to all element included in the set of 5 elements may be expressed by:

$${d}_{i} = {\sum }_{j = 1}^{5} {d}_{ij} .$$

Accordingly, dᵢ may represent the level of similarity of image rᵢ to a query (e.g., query 110), to a subset of images, e.g., a similarity of image 140 to images 115, 120, 145 and 125. In some embodiments, dᵢ may be the sum of distances from an image in a first subset to all images in a second subset. Accordingly, dᵢ may be used to sort the set of Rᵢ, e.g., the set may be resorted in an ascending or descending order according to dᵢ. For example, a level of similarity may be a reciprocal of the distance such that a level of similarity between two images is increased as the distance between them decreases. In sorting elements as described herein, any modifications or other processing may be performed with respect to the value produced by ∥rᵢ−rⱼ∥ in the above equation.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method of identifying outliers, the method comprising:
selecting, from a first subset of digital objects, a second subset of digital objects;
sorting the first subset of digital objects according to a similarity to at least some of the objects included in the second subset; and
designating at least one digital object included in the first subset as an outlier based on the sorting.

2. The method of claim 1, comprising defining the first subset by:
associating with each digital object included in a set of digital objects a value according to a similarity between the digital object and an input digital object;
sorting the set of digital objects according to their associated values; and
selecting the first subset from the set of digital objects, based on the sorting.

3. The method of claim 1, comprising associating with each digital object included in the first subset a cumulative value according to a similarity between the digital object and each of the digital objects included in the second subset and sorting the first subset according to the cumulative values.

4. The method of claim 1, wherein the digital objects contain digital images.

5. The method of claim 1, comprising presenting at least some of the digital objects to a user according to the sorting.

6. The method of claim 3, wherein the a measure of a similarity between digital images is based on a location of the digital images in a space and wherein the dimensions of the space include at least one imaging parameter included in the list consisting of: a color distribution, a hue, an intensity, a brightness, a luminance, a chromaticity and a saturation.

7. An article comprising a non-transitory computer-readable storage medium, having stored thereon instructions, that when executed on a computer, cause the computer to:
select, from a first subset of digital objects, a second subset of digital objects;
sort the first subset of digital objects according to a similarity to at least some of the objects included in the second subset; and
designate at least one digital object included in the first subset as an outlier based on the sorting.

8. The article of claim 7, wherein the instructions when executed further result in defining the first subset by:
associating with each digital object included in a set of digital objects a value according to a similarity between the digital object and an input digital object;
sorting the set of digital objects according to their associated values; and
selecting the first subset from the set of digital objects, based on the sorting.

9. The article of claim 7, wherein the instructions when executed further result in associating with each digital object included in the first subset a cumulative value according to a similarity between the digital object and each of the digital objects included in the second subset and sorting the first subset according to the cumulative values.

10. The article of claim 7, wherein the digital objects contain digital images.

11. The article of claim 7, wherein the instructions when executed further result in presenting at least some of the digital objects to a user according to the sorting.

12. The article of claim 9, wherein the a measure of a similarity between digital images is based on a location of the digital images in a space and wherein the dimensions of the space include at least one imaging parameter included in the list consisting of: a color distribution, a hue, an intensity, a brightness, a luminance, a chromaticity and a saturation.
